(19) United States
(12) Patent Application Publication
(10) Pub. No.: US 2005/0018283 A1
(43) Pub. Date: Jan. 27, 2005

(54) POSITIONING STAGE

(75) Inventor: Hideo Kimura, Shiga-ken (JP)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/709,929

(22) Filed: Jun. 7, 2004

(30) Foreign Application Priority Data
Jun. 23, 2003 (JP) 2003-177545

(51) Int. Cl. G02B 21/26

(52) U.S. Cl. 359/393

(57) ABSTRACT

A positioning stage 10 is constructed of a base 12, a Y-axis direction positioning means 14, and an X-axis direction positioning means 16. The Y-axis direction positioning means 14 is a means for moving an object in a Y-axis direction to position it. The Y-axis direction positioning means 14 is provided with a first table 24(1), a first joint 26(1), a first clutch 28(1), and a first forcibly-moving means 30(1). An X-axis direction positioning means 16 is provided with a second table 24(2), a second joint 26(2), a second clutch 28(2), and a second forcibly-moving means 30(2).

### BACKGROUND OF INVENTION

The invention relates to a positioning stage used for observation, inspection, measurement, or production.

In the past, a positioning stage for positioning an object for manufacture or the like of electronic equipment has been used. Japanese Unexamined Patent Application Publication No. S60-39044 discloses a positioning stage wherein an XY table apparatus in which a table is moved in X-axis and Y-axis directions by a screw mechanism. The XY table apparatus permits fine adjustment of the position of an object by jogging a fine adjusting member to which an object to be positioned is installed while supporting the fine adjusting member with a fluid. However, a large XY table apparatus used for large objects is required to be equipped with a large-scale fluid controller. Furthermore, it is not easy to control fluids. Japanese Unexamined Patent Application Publication No. H11-95123 discloses another positioning stage comprising a microscope stage for positioning specimens to be observed. The microscope stage allows an object to be moved in an electromotive mode or a manual mode. However, the microscope stage is designed for minute objects, so that it is not easy to directly apply its structure for a larger stage.

Thus, there is a need for a positioning stage that can be large-sized. Specifically, there is a need for a positioning stage that can be constructed so as to be lightweight when it is large-sized and that enables easy and accurate positioning.

### SUMMARY OF INVENTION

A positioning stage in accordance with the invention includes a base having a first rail on its top surface, a first table slidable along the first rail and having a second rail perpendicular to the first rail on its top surface, a first joint (coupler) freely movable together with the first table toward the first rail relative to the base, a first clutch for fixing the first joint to the base or releasing it from the base, a first forcibly-moving means for moving the first table toward the first rail relative to the first joint, a second table slidable along the second rail, a second joint freely movable together with the second table toward the second rail relative to the first rail, a second clutch for fixing the second joint to the first table or releasing it from the first table, and a second forcibly-moving means for moving the second table toward the second rail relative to the second joint. In the present specification, the concept of “directions” includes both positive vectors and negative vectors.

A positioning stage in accordance with the invention includes a base having a rail on its top surface, a table slidable along the rail, a joint freely movable together with the table toward the rail relative to the base, a clutch for fixing the joint to the base or releasing it from the base, and a forcibly-moving means for moving the table toward the rail relative to the joint.

A positioning stage of the invention has a structure in which a joint is fixed to a base or a first table by a clutch and a table position is finely adjusted by moving the table relative to the joint. It enables a smaller fine-adjustment mechanism. Therefore, the positioning stage of the invention can be constructed so as to be lightweight and compact even if it is large-sized. In other words, the positioning stage according to the invention is capable of easy fine adjustment of an object position and of coping with a demand for a larger positioning stage. For example, a positioning stage with sides of approximately 1 meter can be constructed to be lightweight and compact.

These and other aspects of the invention are described in further detail below.

### BRIEF DESCRIPTION OF DRAWINGS

FIG. 1 is a top view showing a positioning stage in accordance with the invention.

FIG. 2 is a front view of the positioning stage shown in FIG. 1.

FIG. 3 is an enlarged top sectional view of the positioning stage shown in FIG. 1.

FIG. 4 includes enlarged views of a clutch of the positioning stage shown in FIG. 1, FIG. 4(a) being an enlarged top view showing a state wherein the clutch has been actuated, FIG. 4(b) being an enlarged top view showing a state wherein the clutch has been released, and FIG. 4(c) being an enlarged side view showing a state wherein the clutch has been actuated.

FIG. 5 is an enlarged top view for explaining an operation of the positioning stage shown in FIG. 1.

FIG. 6 is a top view for explaining another embodiment of the positioning stage in accordance with the invention.

FIG. 7 is a system block diagram for explaining still another embodiment of the positioning stage in accordance with the invention.

FIG. 8 is a front view for explaining still another embodiment of the positioning stage in accordance with the invention.

FIG. 9 is a front view for explaining still another embodiment of the positioning stage in accordance with the invention.

FIG. 10 includes enlarged views showing another embodiment of the clutch of the positioning stage in accordance with the invention, FIG. 10(a) being an enlarged top view showing a state wherein the clutch has been actuated and FIG. 10(b) being an enlarged top view showing a state wherein the clutch has been released.

FIG. 11 is an enlarged top view showing yet another embodiment of the clutch of the positioning stage in accordance with the invention.

FIG. 12 is an enlarged top sectional view showing still another embodiment of the positioning stage shown in FIG. 1.

FIG. 13 is a top view showing a further embodiment of the positioning stage in accordance with the invention.

FIG. 14 is a top view showing a further embodiment of the positioning stage in accordance with the invention.

FIG. 15 is a top view showing a further embodiment of the positioning stage in accordance with the invention.

### DETAILED DESCRIPTION

An embodiment of a positioning stage in accordance with the invention will now be explained in detail with reference to the accompanying drawings.

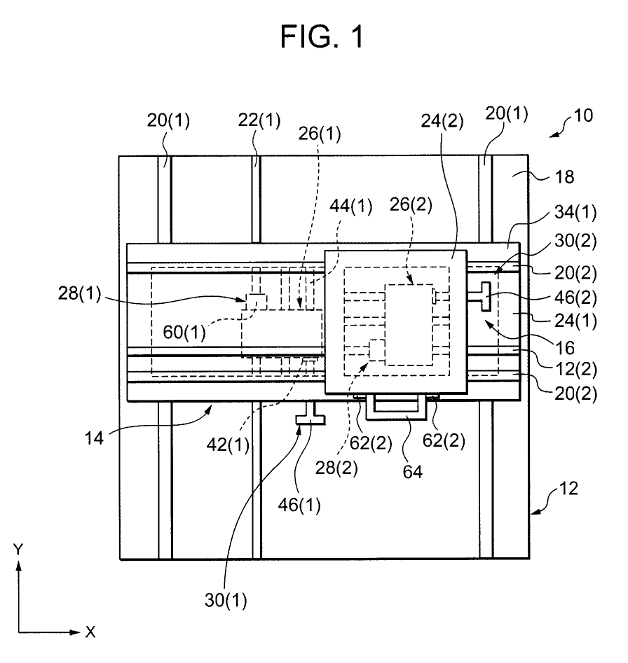

Referring to FIG. 1 through FIG. 4, a positioning stage 10 in accordance with the invention is an apparatus for positioning objects in two-dimensional directions (XY directions). The positioning stage 10 is constructed of a base 12, a Y-axis direction positioning means 14, and an X-axis direction positioning means 16.

The base 12 has two first rails 20(1) that are mounted on a top surface 18 such that they are parallel to the Y-axis. The base 12 also has a plate 22(1) mounted on the top surface 18 such that it is parallel to the first rails 20(1).

The Y-axis direction positioning means 14 moves and positions objects in the Y-axis direction. The Y-axis direction positioning means 14 has a first table 24(1), a first joint 26(1), a first clutch 28(1), and a first forcibly-moving means 30(1). The first joint 26(1) and the first clutch 28(1) are built into the first table 24(1), thus preventing an operator from accidentally pinching his/her fingers by these components. This arrangement of mechanical structure enhances the safety and appearance of the positioning stage 10.

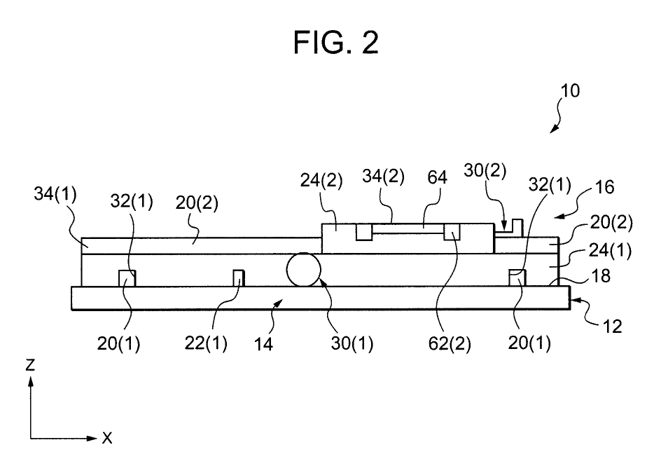

As shown in FIG. 2, the bottom surface of the first table 24(1) has grooves 32(1) slidably engaged with the first rails 20(1) so as to be slidable along the first rails 20(1). The first table 24(1) has, on its top surface 34(1), second rails 20(2) perpendicular to the first rails 20(1). The first table 24 further has, on its top surface 34(1), a plate 22(2) parallel to the first rails 20(1).

The first joint 26(1) is built into the first table 24(1) and connected to the first table 24(1) through the intermediary of the first forcibly-moving means 30(1). The first joint 26(1) can be connected to the plate 22(1) through the intermediary of the first clutch 28(1). This structure enables the first joint 26(1) to connect the first table 24(1) and the base 12 through the intermediary of the plate 22(1). The first joint 26(1) becomes free to travel together with the first table 24(1) toward the first rails 20(1) relative to the base 12 when the first clutch 28(1) is released.

The first clutch 28(1) built into the first table 24(1) is comprised of a first clamping mechanism and a clutch driving device, the structure being identical to that of a second clutch 28(2). Hence, detailed explanation of the first clutch 28(1) is true of the explanation of the second clutch 28(2).

The first forcibly-moving means 30(1) is comprised of a male screw 44(1) that is threaded into a female screw 42(1) of the first joint 26(1) and connected to the first table 24(1) such that it can be rotated but cannot be moved to axial direction, and a knob 46(1) for rotating the male screw 44(1) by hand. The first forcibly-moving means 30(1) is capable of moving the first table 24(1) toward the first rails 20(1) relative to the first joint 26(1) by rotating the knob 46(1). The first forcibly-moving means 30(1) is capable of moving the first table 24(1) by the screw mechanism, so that it is capable of fine adjusting the first table 24(1).

The X-axis direction positioning means 16 moves and positions objects in the Y-axis direction. The X-axis direction positioning means 16 has a second table 24(2), a second joint 26(2), a second clutch 28(2), and a second forcibly-moving means 30(2). The second joint 26(2) and the second clutch 28(2) are built into the second table 24(2), thus preventing an operator from accidentally pinching his/her fingers or the like by these components. This arrangement of mechanical structure enhances the safety and appearance of the positioning stage 10. Moreover, the X-axis direction positioning means 16 has the second joint 26(2) and the second clutch 28(2) compactly integrated in the table 24(2), making it easy to reduce contamination from this mechanism.

Grooves (not shown) in the bottom surface of the second table 24(2) are slidably engaged with the second rails 20(2) so as to be slidable along the second rails 20(2). The top surface 34(2) of the second table 24(2) is formed to be flat to allow an object to be mounted thereon.

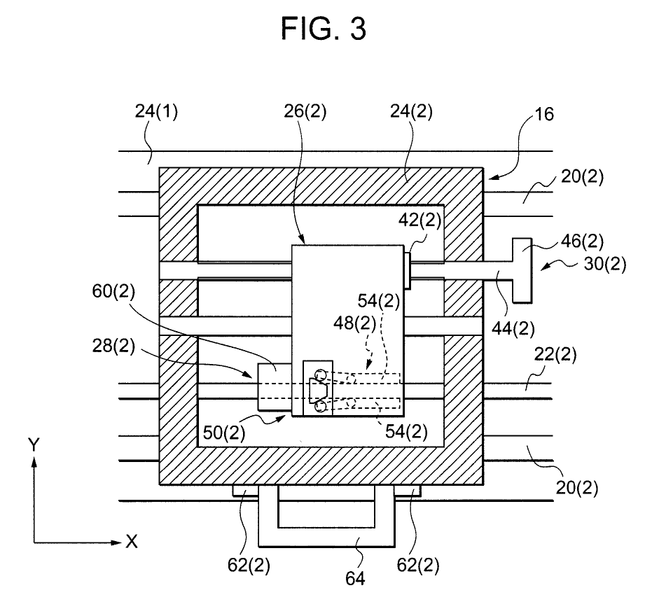

The second joint 26(2) is built into the second table 24(2) and connected to the second table 24(2) through the intermediary of the second forcibly-moving means 30(2), as shown in FIG. 3. The second joint 26(2) can be connected to the plate 22(2) through the intermediary of the second clutch 28(2). This structure enables the second joint 26(2) to connect the second table 24(2) and the first table 24(1) through the intermediary of the plate 22(2). The second joint 26(2) becomes free to travel together with the second table 24(2) toward the second rails 20(2) relative to the first table 24(1) when the second clutch 28(2) is released.

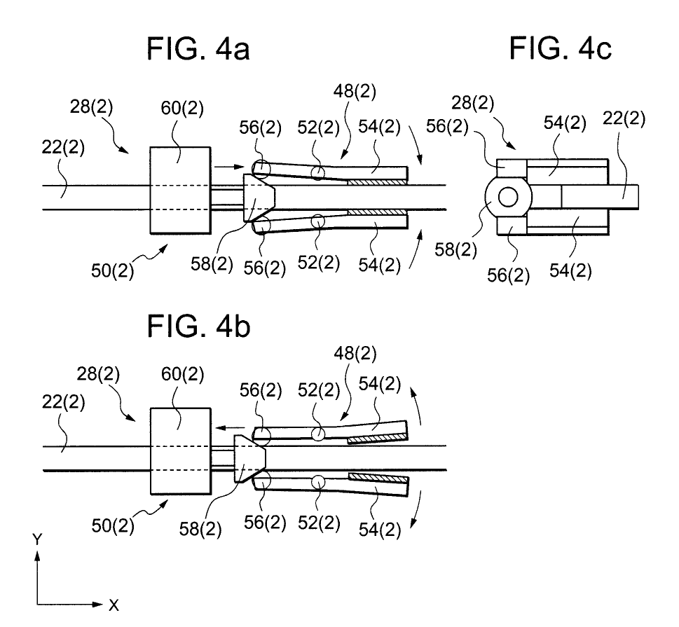

The second clutch 28(2) built into the second table 24(2) is comprised of a second clamping mechanism 48(2) and a clutch driving means 50(2), as shown in FIG. 3 and FIG. 4. The second clamping mechanism 48(2) consist of a pair of pressing members 54(2) that rotates around a pin 52(2) to come in contact with or move away from the plate 22(2). The clutch driving means 50(2) is comprised of a piston 58(2) that pushes projecting members 56(2) secured to the pair of pressing members 54(2) to rotate the pressing members 54(2), and an air cylinder 60(2) that reciprocates the piston 58(2). The pair of pressing members 54(2) is axisymmetrical to the plate 22(2). Hence, when the pair of pressing members 54(2) clamps the plate 22(2), the second clutch 28(2) will not be dislocated in a direction perpendicular to the second rail 20(2).

Referring to FIG. 3, the second forcibly-moving means 30(2) is comprised of a male screw 44(2) that is threaded into a female screw 42(2) of the second joint 26(2) and connected to the second table 24(2) such that it can be rotated but cannot be moved to axial direction, and a knob 46(2) for rotating the male screw 44(2) by hand. The second forcibly-moving means 30(2) is capable of moving the second table 24(2) toward the second rails 20(2) relative to the second joint 26(2) by rotating the knob 46(2).

Furthermore, in the positioning stage 10, second switches 62(2) for driving the air cylinder 60(2) are provided on the outer peripheral surface of the second table 24(2). The positions of first switches for driving an air cylinder 60(1) are not particularly restricted as long as they are on the outer peripheral surface of the positioning stage 10. A handle 64 for moving the second table 24(2) with the like of by hand is provided on the outer peripheral surface of the second table 24(2). The second switches 62(2) are provided on the right and left sides, respectively, of the handle 64 so as to be compatible whether an operator who holds the handle and presses the second switch 62(2) with his/her thumb is right-handed or left-handed.

The operator who tries to align, by using the positioning stage 10 having the structure described above, loads the second table 24(2) with the object at first. Then, the operator releases the clutches 28(1) and (2) so as to set the first table 24(1) free to move in the Y-axis direction and the second table 24(2) free to move in the X-axis direction. In this state, the operator holds the handle 64 and moves the first table 24(1) in the Y-axis direction and the second table 24(2) in the X-axis direction, respectively, thereby to move the object to the vicinity of a target position. Moving the object to the vicinity of the target position is easier than doing by a motorized mechanism, since it is performed by hand in a freely movable state. In addition, an operation such as to keep pressing a switch to drive motorized mechanism is not required, so that the object is quickly moved to the vicinity of the target position.

Then, the clutch 28(1) is operated by pressing the first switch to secure the joint 26(1) to the base 2 through the intermediary of the plate 22(1). Furthermore, the clutch 28(2) is operated by pressing the second switch 62(2) to secure the joint 26(2) to the first table 24(1) through the intermediary of the plate 22(2). The first switch and the second switch 62(2) accomplish instant changeover from a free travel mode to a fine adjusting mode. In this state, the knob 46(1) is rotated to move the first table 24(1) in the Y-axis direction relative to the joint 26(1). Since the joint 26(1) is secured to the base 12, the first table 24(1) is moved in the Y-axis direction relative to the base 12 when the knob 46(1) is rotated.

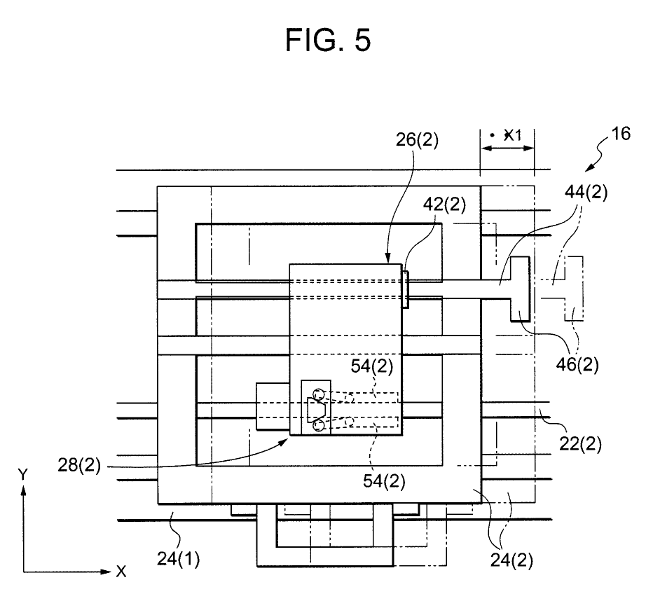

Similarly, the knob 46(2) is rotated to move the second table 24(2) in the X-axis direction relative to the first table 24(1). This operation will be explained in detail in conjunction with FIG. 5. The pressing members 54(2) of the clutch 28(2) clamp the plate 22(2) to secure the joint 26(2) to the first table 24(1). Meanwhile, since the male screw 44(2) has been threaded in the female screw 42(2), turning the knob 46(2) to rotate the male screw 44(2) causes the male screw 44(2) to travel by DX1 in the X-axis direction relative to the joint 26(2). Thus, the male screw 44(2) travels by DX1 relative to the first table 24(1). The male screw 44(2) is connected to the second table 24(2) such that it is rotatable but cannot be moved to axial direction, so that the second table 24(2) moves together with the male screw 44(2) by DX1 relative to the first table 24(1). In this manner, the knobs 46(1) and 46(2) are rotated to fine adjust an object position on the second table 24(2) in the XY directions, permitting the object to be accurately positioned. The positioning accuracy of this stage is within the range from about 1.0 mm to about 0.1 mm. In the free travel mode, the object can be moved to the vicinity of the target position, so that the travel of fine adjusting for positioning the object by means of the knobs 46(1) and 46(2) may be from about −10 mm to about +10 mm.

As described above, the clutches 28(1) and 28(2) are released to move the object on the second table 24(2) by hand, and then the clutches 28(1) and 28(2) are secured and the knobs 46(1) and 46(2) are rotated to fine adjust the object position. Thus this structure makes it possible to position the object accurately and quickly.

The above has described one embodiment of the invention. The invention can be implemented by other embodiment.

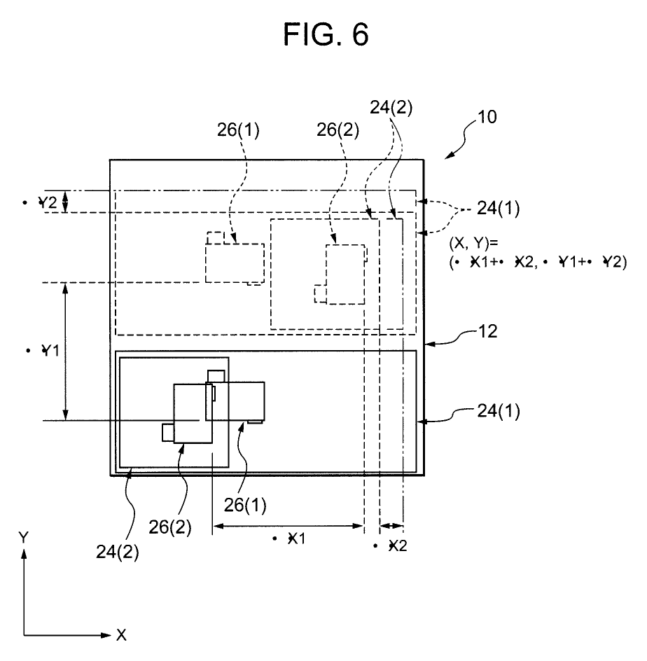

For example, the positioning stage 10 may be provided with a line sensor for measuring a travel distance DY1 of the first joint 26(1) in relation to the base 12 in the free travel mode, a line sensor for measuring a travel distance DY2 of the first table 24(1) in relation to the first joint 26(1) in the fine adjusting mode, a line sensor for measuring a travel distance DX1 of the second joint 26(2) in relation to the first table 24(1) in the free travel mode, and a line sensor for measuring a travel distance DX2 of the second table 24(2) in relation to the second joint 26(2) in the fine adjusting mode. Referring to FIG. 6, the tables 24(1) and 24(2) positioned at their origins are indicated by solid lines, the tables 24(1) and 24(2) are indicated by dashed lines after they are moved from their origins in the free travel mode, and the tables 24(1) and 24(2) are indicated by the two-dot chain lines after they are moved in the fine adjusting mode. Coordinates (X, Y) after positioning are represented by (DX1+DX2, DY1+DY2).

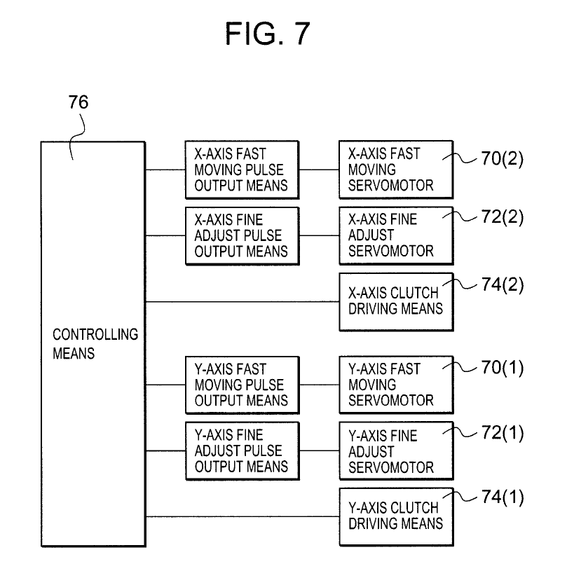

The positioning stage 10 may alternatively be provided with a Y-axis fast moving servomotor 70(1) for moving the first joint 26(1) relative to the base 12 at high speed in a free mode, a Y-axis fine adjusting servomotor 72(1) for moving the first table 24(1) relative to the first joint 26(1) in a fine adjusting mode, an X-axis fast moving servomotor 70(2) for moving the second joint 26(2) relative to the first table 24(1) at high speed in a free mode, and an X-axis fine adjusting servomotor 72(2) for moving the second table 24(2) relative to the second joint 26(2) in a fine adjusting mode. In this case, a control system shown in FIG. 7 is provided. A controlling means 76 releases the first clutch 28(1) by a Y-axis clutch driving means 74(1) to drive the Y-axis fast moving servomotor 70(1), and the first clutch 28(1) is actuated by a Y-axis clutch driving means 74(1) to drive the Y-axis fine adjusting servomotor 72(1). Similarly, the controlling means 76 releases the second clutch 28(2) by the X-axis clutch driving means 74(2) to drive the X-axis fast moving servomotor 70(2), and the second clutch 28(2) is actuated by the X-axis clutch driving means 74(2) to drive the X-axis fine adjusting servomotor 72(2).

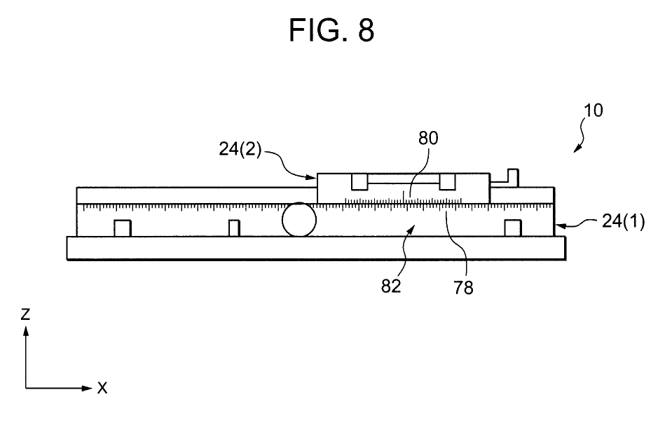

The positioning stage 10 may be equipped with a vernier scale 82 having a main scale 78 provided on the first table 24(1) and a vernier scale 80 provided on the second table 24(2), as shown in FIG. 8. This arrangement enables an operator to accurately determine the position of the second table 24(2) in relation to the first table 24(1) by the vernier scale 82. The positioning stage 10 may alternatively be equipped with a vernier scale that is similar to the vernier scale 82 and that permits determination of the position of the first table 24(1) relative to the base 12.

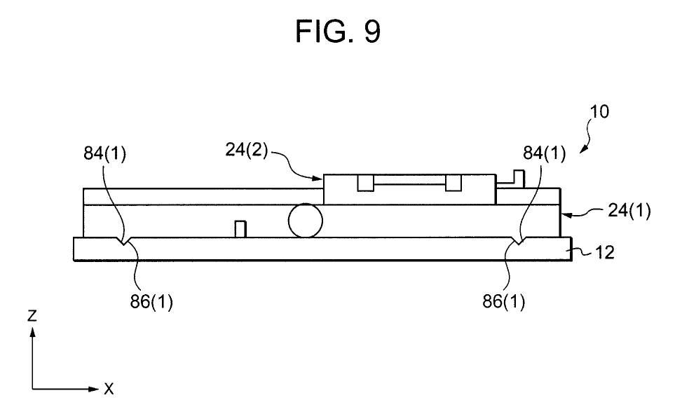

The first rails and the second rails of the positioning stage 10 may have a groove-like shape rather than the projecting-upward shape as in the rails 20(1) and 20(2). For example, the rails may be formed of first rails 84(1), as shown in FIG. 9. In this case, projections 86(1) slidably engaged with the first rails 84(1) are provided on the bottom surface of the first table 24(1).

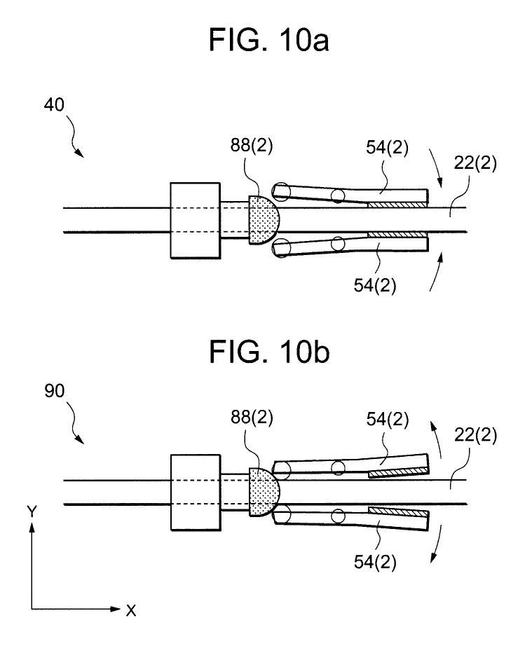

The clutch of the positioning stage 10 may be a clutch 90(2) for rotating pressing members 54(2) by an electromagnet 88(2), as shown in FIG. 10. In this case, the pressing members 54(2) move away from a plate 22(2) when magnetic forces are produced in the electromagnet 88(2) by a switch (not shown), while the pressing members 54(2) clamp the plate 22(2) by an urging means (not shown) when the magnetic forces are cleared.

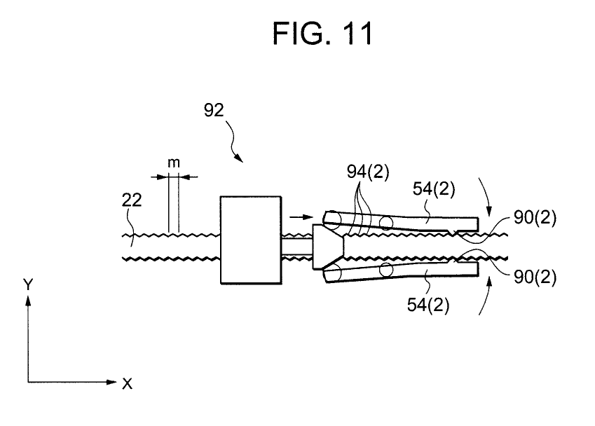

Alternatively, the clutch of the positioning stage 10 may be a clutch 92(2) provided with projections 90(2) in the vicinity of the distal ends of the pressing members 54(2), as shown in FIG. 11. In this case, the plate 22(2) is provided with a number of recessed portions 94(2) with which the projections 90(2) engage. The clutch 92(2) is secured to the plate 22(2) by engaging the projections 90(2) with the recessed portions 94(2). The clutch 92(2) is dislocated in the X-axis direction by not more than a distance equivalent to a pitch of the recessed portions when the projection 90(2) engages the recessed portions 94(2). This, however, does not cause a problem, because fine adjustment is performed in the fine adjusting mode.

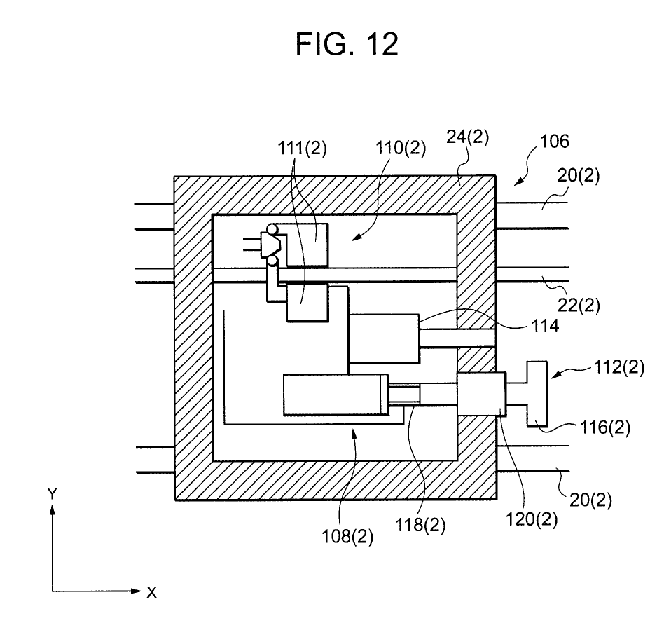

The X-axis direction positioning means of the positioning stage 10 may be formed of an X-axis direction positioning means 106 shown in FIG. 12. The X-axis direction positioning means 106 is equipped with a second table 24(2), a second joint 108(2), a second clutch 110(2), and a second forcibly-moving means 112(2). The joint 108(2) is provided with a linear guide 114(2) so as to be able to smoothly move without side run-out in a direction parallel to the plate 22(2). The second clutch 110(2) does not incur an impact when two pressing members 111(2) clamp the plate 22(2), because the two pressing members 111(2) grip the plate 22(2) therebetween under spring pressure (not shown). A clamping force required of the two pressing members 111(2) is sufficient as long as it allows an operation, such as applying a probing needle to an electronic component on the table 24(2). The second forcibly-moving means 112(2) has a ball friction reduction gear 120(2) for reducing the number of revolutions of a male screw 118(2) to be less than the number of revolutions of a knob 116(2). If, for example, the reduction ratio of the ball friction reduction gear 120(2) is 1/20, and the lead of the male screw 118(2) is L=2 mm, then a travel distance in the X-axis direction when the knob 116(2) is rotated once will be 2×(1/20)=0.1[mm/revolution]. If a diameter D of the knob 116(2) is set to 63.6 mm, then the length of its outer circumference will be pD will be about 200 mm. If the outer circumference of the knob 116(2) is rotated by R=1 mm by hand, then the travel distance in the X-axis direction will be 0.1×(R/pD)=0.1×(1/p×63.6)=0.0005 mm. Accordingly, if L is set to 2 to 5 mm, then the travel distance in the X-axis direction will be 0.05L×R/pD=0.0005 to 0.00125 mm. Thus, if the outer circumference of the knob 116(2) is rotated 1 mm by hand, then the travel distance in the X-axis direction will be 0.0005 to 0.00125 mm. This allows accurate positioning of 0.5 mm to a few mm to be accomplished by means of the knob 116(2).

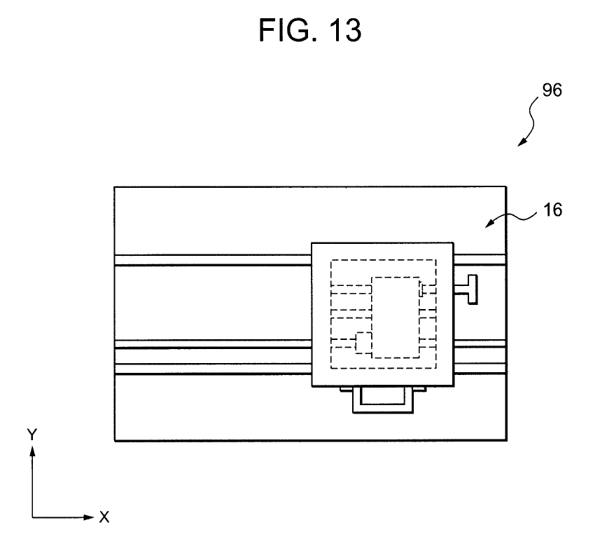

The positioning stage in accordance with the invention may be a positioning stage 96 shown in FIG. 13. The positioning stage 96 is provided only with an X-axis direction positioning means 16 and therefore capable of positioning only in the X-axis direction.

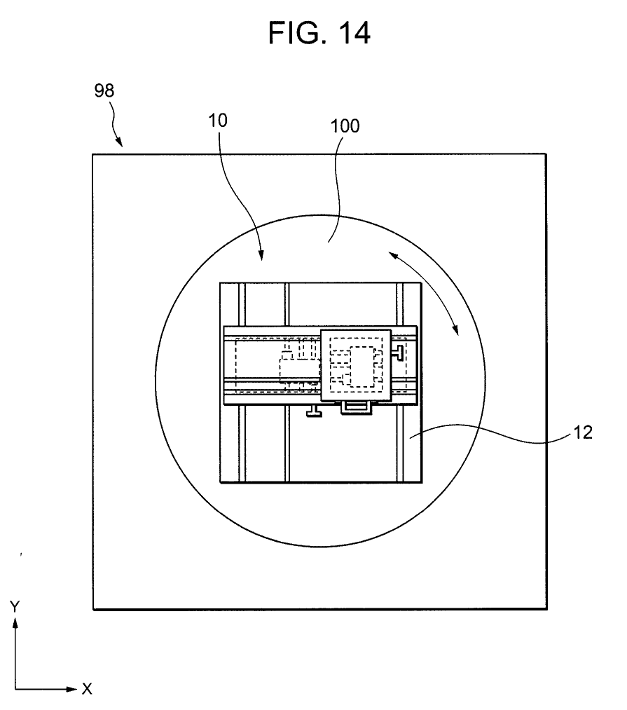

The positioning stage in accordance with the invention may be a positioning stage 98 shown in FIG. 14. The positioning stage 98 is constructed by securing the positioning stage 10 on a rotatable disc 100. In this case, the direction of the base 12 itself can be changed.

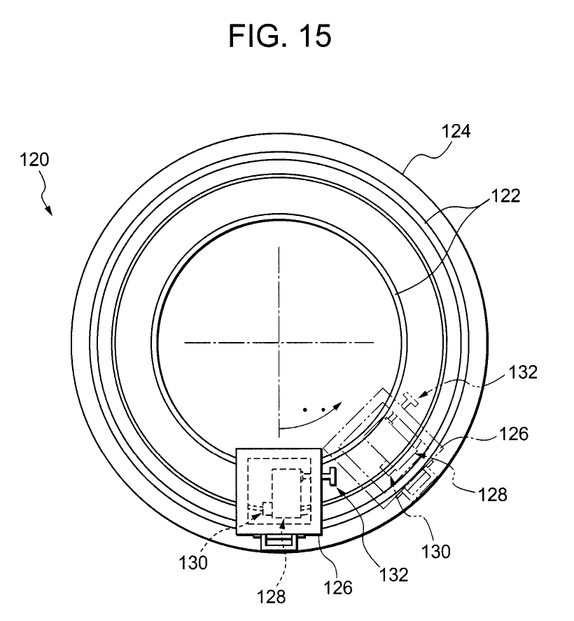

The positioning stage in accordance with the invention may be a positioning stage 120 shown in FIG. 15. The positioning stage 120 is provided with a base 124 having circular rails 122 on its top surface, a table 126 slidable along the rails 122, a joint 128 freely movable together with a table 126 toward the rails 122 relative to the base 124, a clutch 130 for fixing the joint 128 to the base 124 or releasing it from the base 124, and a forcibly-moving means 132 for moving the table 126 toward the rails 122 relative to the joint 128. The positioning stage 120 allows the table 126 to be moved in a circular direction and positioned by hand and the forcibly-moving means 132.

The technological scope of the invention is intended to cover various improvements, changes, or modifications on the basis of the knowledge of persons skilled in the art within the sprit thereof. Furthermore, the invention may be implemented in the form of modes wherein any particular aspects of the invention are substituted by other technologies within a range wherein the same operations or advantages are obtained.

1. A positioning stage, comprising:
a base having a first rail on its top surface;
a first table slidable along said first rail and having a second rail perpendicular to said first rail on its top surface;
a first joint freely movable together with said first table toward said first rail relative to said base;
a first clutch for fixing said first joint to said base or releasing it from said base;
first forcibly-moving means for moving said first table toward said first rail relative to said first joint;
a second table slidable along said second rail;
a second joint freely movable together with said second table toward said second rail relative to said first rail;
a second clutch for fixing said second joint to said first table or releasing it from said first table; and
a second forcibly-moving means for moving said second table toward said second rail relative to said second joint.

2. The positioning stage according to claim 1, wherein said first table is moved toward said first rail relative to said base by said first forcibly-moving means when said first clutch secures said first joint to said base, while said second table is moved toward said second rail relative to said first table by said second forcibly-moving means when said second clutch secures said second joint to said first table.

3. The positioning stage according to claim 2, wherein said first table becomes freely slidable relative to said base when said first clutch releases said first joint from said base, while said second table becomes freely slidable relative to said first table when said second clutch releases said second joint from said first table.

4. The positioning stage according to claim 3, wherein
said base comprises a plate parallel to said first rail on its top surface,
said first clutch comprises a first clamping mechanism for clamping said plate,
said first table comprises a plate parallel to said second rail on its top surface, and
said second clutch comprises a second clamping mechanism for clamping said plate.

5. The positioning stage according to claim 4, wherein
said first joint comprises a female screw,
said first forcibly-moving means comprises a male screw threaded into said female screw,
said second joint comprises a female screw, and
said second forcibly-moving means comprises a male screw threaded into said female screw.

6. The positioning stage according to claim 5, wherein
said first clutch comprises a first clutch driving means,
a first switch for driving said first clutch driving means is provided on an outer peripheral surface of a base, a first table or a second table,
said second clutch comprises a second clutch driving means,
a second switch for driving said second clutch driving means is provided on an outer peripheral surface of the base, the first table or the second table.

7. The positioning stage according to claim 6, comprising:
a driving means for sliding said first table along said first rail; and
a driving means for sliding said second table along said second rail.

8. The positioning stage according to claim 6, wherein
said first joint and said first clutch are built into said first table, and
said second joint and said second clutch are built into said second table.

9. A positioning stage, comprising:
a base having a rail on its top surface;
a table slidable along said rail;
a joint freely movable together with said table toward said rail relative to said base;
a clutch for fixing said joint to said base or releasing it from said base; and
forcibly-moving means for moving said table toward said rail relative to said joint.
